(19) United States
(12) Patent Application Publication
(10) Pub. No.: US 2003/0039225 A1
(43) Pub. Date: Feb. 27, 2003

(54) Method of sending a multicast message to mobile stations, and a radio telecommunications network

(76) Inventors: Alessio Casati, Wiltshire (GB); Sudeep Kumar Palat, Wiltshire (GB)

Correspondence Address: Docket Administrator (Rm. 3J-219), Lucent Technologies Inc., 101 Crawfords Corner Road, Holmdel, NJ, 07733-3030, US

(21) Appl. No.: 10/223,536

(22) Filed: Aug. 19, 2002

(30) Foreign Application Priority Data
Aug. 22, 2001 (GB) 0120419.7
Nov. 21, 2001 (EP) 01309800.9

(51) Int. Cl. H04Q 7/00

(52) U.S. Cl. 370/328; 370/432

(57) ABSTRACT

A method is provided of sending a multicast message to mobile stations of a multicast group in cells of a radio telecommunications network. In each cell, a channel is selected for the multicast message. The multicast message is sent on the selected channel for reception by all the mobile stations of the multicast group in that cell. Preferably, the multicast message is only sent in those cells selected as containing mobile stations of the multicast group.

### CROSS REFERENCE TO RELATED APPLICATION

This application claims priority of Great Britain Provisional Application No. 0120419.7 filed on Aug. 22, 2001, and European Application No. 01309800.9, filed on Nov. 21, 2001.

### TECHNICAL FIELD

The present invention relates to a method of sending a multicast message to mobile stations of a multicast group in cells of a radio telecommunications network.

### BACKGROUND OF THE INVENTION

There is a requirement in Universal Mobile Telecommunications Systems (UMTS) standards to support efficient Multicast services.

The known solution is for the gateway general packet radio system (GPRS) support node (GGSN), which is the point of entry to the UMTS network, to duplicate data streams so as to send data over point to point links over the UMTS network. Using point to point links over the UMTS network is inefficient and uses additional resources; not only network resources but also scarce radio resources. This is because the multicast data is sent over the dedicated point to point links. If there are several users in a cell, the same information is sent over several channels, one for each user.

### SUMMARY OF THE INVENTION

The present invention provides a method of sending a multicast message to mobile stations of a multicast group in cells of a radio telecommunications network, each cell having a base station. The method comprises selecting, in each cell, a channel for the multicast message, and sending the multicast message on the selected channel for reception by all the mobile stations of the multicast group in that cell. The multicast message can be multicast data.

Preferred embodiments of the present invention advantageously address sending data without duplicating data over the radio network by using a multicast radio channel which can be dynamically chosen in each cell. A multicast channel allows multiple selected users who are members of the group to receive multicast packets, allowing multicast data to be sent to all the users in a cell just once.

In some embodiments, the multicast message is only sent in those cells selected as having mobile stations of the multicast group located therein. Advantageously, the multicast area is limited to the cells that have users who are part of the multicast group. This avoids wastage of radio resources.

In some embodiments, the multicast message is only sent in those cells selected as having mobile stations of the multicast group located therein and in neighbouring cells.

In some embodiments, the locations of mobile stations of the multicast group are tracked and the cells in which the multicast message is sent are selected in response thereto. Advantageously, the multicast area is actively limited to the relevant cells by tracking the user mobility within the radio access network. This is more efficient than broadcasting over a wider area.

In some embodiments, multicast data is first sent in an area including all cells associated with the radio network, and the cells in which mobiles of the multicast group are determined as being located are selected for sending the multicast message. Preferably the locations of mobile stations in the multicast group are determined by information messages from the mobile stations sent in response to the multicast data

In some embodiments, the locations of mobile stations in the multicast group are determined by paging and analysing paging responses. In this way a paging procedure can be used to “fine tune” the multicast area.

Advantageously, the multicast message is buffered and sent once the locations of the mobile stations in the multicast group have been determined.

In some embodiments, the method includes sending a signal that includes an identifier of the multicast group in advance of the multicast message. This causes the mobile stations in the multicast group to switch from a low power consumption idle state to an higher power consumption active state. This is advantageous as, e.g., a paging procedure to allow terminals to sleep during idle periods to conserve battery power. In other words, the multicast paging procedure allows the mobiles to sleep during idle periods to be woken up only when there is data. Also, the multicast paging method avoids overloading the paging channel.

In another aspect, the present invention provides a radio telecommunications network comprising cells, each cell having a base station, the base station of each cell that includes one or more mobile station of a multicast group being operative to select a channel for the multicast message and send the multicast message on the selected channel for reception by all the mobile stations in the multicast group in that cell.

### BRIEF DESCRIPTION OF THE DRAWINGS

A preferred embodiment of the present invention will now be described by way of example and with reference to the drawings, in which:

FIG. 1 is a diagrammatic illustration of a UMTS/GPRS network, and

FIG. 2 is a diagrammatic illustration of selection by the radio network controller RNC of cells for multicast.

### DETAILED DESCRIPTION

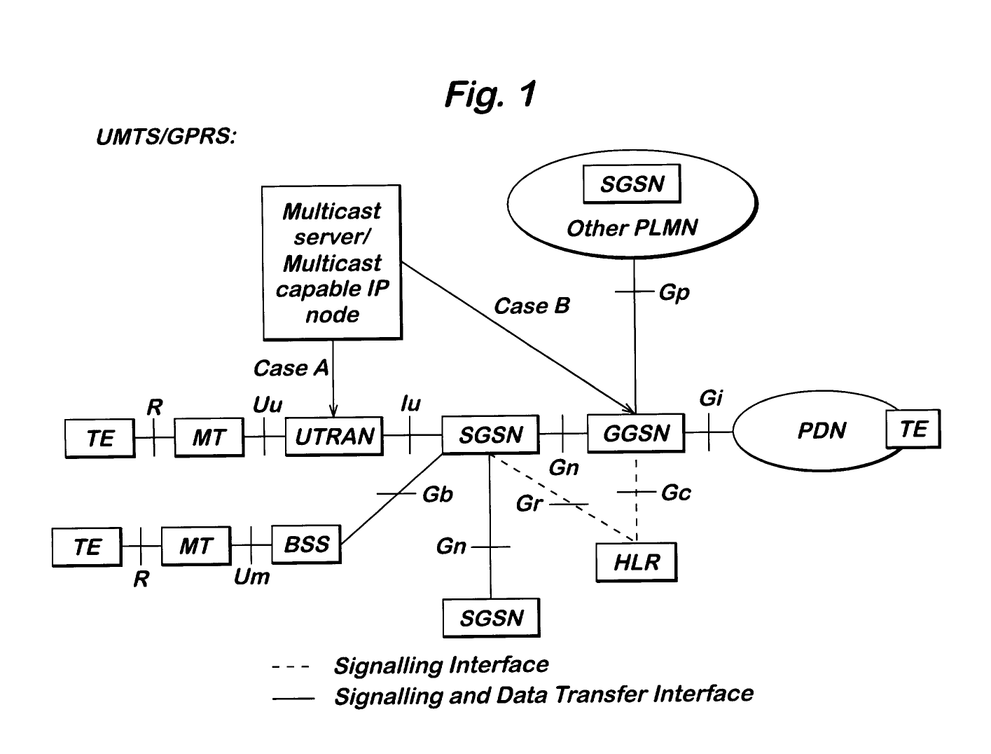

FIG. 1 shows the UMTS/GPRS network architecture. The new network element is the Multicast Server/IP multicast capable IP node. In FIG. 1, MT denotes the mobile termination of the core network and TE denotes the mobile station.

The support of IP multicast transmissions in GPRS/UMTS core networks can be considered as the problem of how to support multicast in a hierarchical tunnel-based mobility support system. A hierarchical tunnel based mobility support system uses compulsory tunnels from an access point that can be rearranged hop by hop up to an anchor point. A typical access point in this context is the base station controller (BSC), the radio network controller RNC, or another wireless or wireline access network termination node

In an illustrative UMTS network, the signalling protocol used at the hierarchical level associated with the anchor point—in this case the gateway GPRS support node (GGSN)—is GPRS tunnelling protocol (GTP) control plane GTP-C. The immediately lower hierarchical level protocol is radio access network application part (RANAP), between serving GPRS support node (SGSN) and radio network controller (RNC). The radio network controller (RNC) is the access point. For user data, the GTP user plane GTP-U is used from the GGSN to the RNC. Alternatively, for second generation 2G GPRS functionality, the access point is the serving GPRS support node (SGSN).

When a mobile node (MN) is expecting multicast data, a PDP context is set up to that mobile node.

Access Network: Procedures in the Radio Network Controller (RNC)

Data for multicast is either sent directly to the radio network controller (RNC) or via the GTP tunnel from the GGSN. The following describes the procedures within the RNC.

Data is sent down a “multicast” channel. This multicast channel can be any of the physical channels already defined in UMTS or a new one. Each mobile node (MN) that belongs to the multicast group is informed of the channel type and details by explicit signalling. These mobile nodes then pick up the multicast channel. The choice of the channel is based on the quality of service (QoS) requirements. The channel details may change from cell to cell or over time. Any such changes—either due to mobile node movement to a different cell or due any change initiated by the network—are also indicated to all the mobile nodes concerned.

Multicast data is only sent to the relevant cells to ensure reception by the mobile nodes. These cells could be decided based on the level of information available to the access point (i.e., the RNC) at that time. This would be at least the cells having mobile nodes in the multicast group, and at most the paging area of all the mobile nodes associated with the RNC. The number of cells to which multicast data is to be sent is then reduced, to eliminate transmission to unnecessary cells, once the locations of the users are known more accurately. Identifying the location of the users can, for example, be based on paging/paging response combinations or mobile-node-initiated cell updates on detection of multicast data.

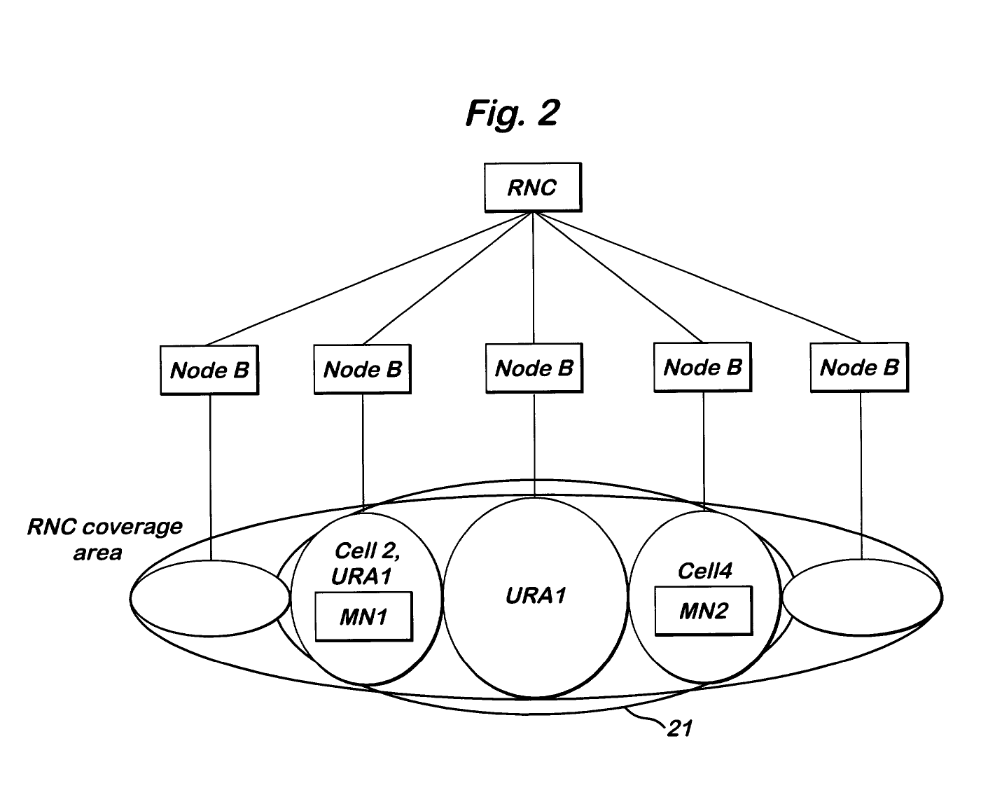

As shown in FIG. 2, to illustrate if mobile node MN1 and mobile node MN2 belong to a multicast group, the RNC knows that mobile node MN1 is located in UTRAN registration area URA1 and mobile node MN2 is in cell 4. UTRAN denotes UMTS terrestrial radio access network. As shown in FIG. 2, each radio network controller controls several base station antennas (Node B's), each having an associated coverage area (cell). Thus the initial multicast area 21 is UTRAN registration area URA1 and Cell 1. When the location of mobile node MN1 is known at a cell level, the multicast area is then reduced to Cell 2 and Cell 4. In some embodiments, the multicast channels are also made available in cells that neighbor on those that contain the mobile nodes in the multicast group, depending on QoS level, so that the handoff may happen with minimum impact.

Conserving Battery Power

Multicast data transmission can be discontinuous with idle periods between periods of activity. To conserve battery power, it is desirable to avoid each mobile node in the multicast group having to monitor the multicast channel at all times. This is achieved by sending a paging message in the paging channel addressed with a special identifier. The special identifier identifies all users belonging to this multicast group associated with the RNC. This identifier must be communicated at set-up time to the mobile node. The paging message is sent to those cells which cover the region of uncertainty of user locations.

The users can be in different states with respect to the RNC: Cell-dedicated channel (DCH) with and without soft handover, Cell-FACH, PCH or URA-PCH. In states of channel DCH without soft handover, cell-FACH and Cell-PCH, where the user is known at a cell level, the paging procedure is limited to the cell in which the user is located. On the other hand in URA-PCH state, the paging area and multicast area must include the UTRAN registration area (URA). Paging responses from users in URA-PCH state or idle state are then used to reduce the multicast area as described above. Another option is to buffer data until the paging response is received, and then include in the multicast area only those cells in which the mobile nodes of the multicast group are located. Other methods to optimise the multicast area are possible.

Changes in paging area between cell specific and larger paging areas such as UTRAN registration area (URA) are controlled explicitly by the RNC using messaging and/or timers of idle periods.

Encryption

The multicast radio bearers could be encrypted by the source radio network controller (SRNC) using a locally generated key applicable for all the users belonging to the group. A new key is then issued periodically to all users, using dedicated signalling radio bearer channels. The key is made available to new users when they join the group or move from one RNC to another. Another option is to use application level encryption.

We claim

1. A method of sending a multicast message to mobile stations of a multicast group in cells of a radio telecommunications network, each cell having a base station, comprising: in each cell, selecting a channel for the multicast message; and sending the multicast message on the selected channel for reception by all the mobile stations of the multicast group in that cell.

2. A method of sending a multicast message according to claim 1, in which the multicast message is sent only in those cells selected as having mobile stations of the multicast group located therein.

3. A method of sending a multicast message according to claim 1, in which the multicast message is sent only in those cells selected as having mobile stations of the multicast group located therein and in neighbouring cells.

4. A method of sending a multicast message according to claim 1, in which the locations of mobile stations of the multicast group are tracked and the cells in which the multicast message is sent is selected in consequence.

5. A method of sending a multicast message according to claim 1, in which multicast data is first sent in an area including all cells associated with the radio network, and then cells determined to contain mobiles of the multicast group are selected for sending the multicast message.

6. A method of sending a multicast message according to claim 5, in which the locations of mobile stations in the multicast group are determined by information messages from the mobile stations sent in response to the multicast data.

7. A method of sending a multicast message according to claim 1, in which the locations of mobile stations in the multicast group are determined by paging and analysing paging responses.

8. A method of sending a multicast message according to claim 1, in which the multicast message is buffered, and is sent after the locations of the mobile stations in the multicast group have been determined.

9. A method of sending a multicast message according to claim 1, further comprising sending a signal including an identifier of the multicast group in advance of the multicast message, thereby to cause the mobile stations in the multicast group to switch from a low power-consumption idle state to a higher power-consumption active state.

10. A radio telecommunications network arranged into cells, wherein: each cell has a base station; at least one multicast group, to which mobile stations can belong, is defined; and in each cell that includes one or more mobile stations of a multicast group, the corresponding base station is operative to select a channel for the multicast message and send the multicast message on the selected channel for reception by all the mobile stations in the multicast group in that cell.
